(19) United States
(12) Patent Application Publication
(10) Pub. No.: US 2016/0217379 A1
(43) Pub. Date: Jul. 28, 2016

(54) Shapelet-Based Oilfield Equipment Failure Prediction and Detection

(71) Applicant: University of Southern California, Los Angeles, CA (US)

(72) Inventors: Om Prasad Patri, Los Angeles, CA (US); Anand V. Panangadan, Los Angeles, CA (US); Charalampos Chelmis, Los Angeles, CA (US); Nabor Reyna, JR., Houston, TX (US); Randall G. McKee, Katy, TX (US); Viktor K. Prasanna, Los Angeles, CA (US); Rajgopal Kannan, Los Angeles, CA (US)

(21) Appl. No.: 15/007,975

(22) Filed: Jan. 27, 2016

Related U.S. Application Data
(60) Provisional application No. 62/108,477, filed on Jan. 27, 2015.

(51) Int. Cl. G06N 5/04; G06N 99/00

(52) U.S. Cl. CPC G06N 5/04; G06N 99/005

(57) ABSTRACT

A method for predicting a failure of oilfield equipment based on univariate time series includes providing training data by a sensor. A training data stream comprising the training data is received by a preprocessor. The method further includes extracting training data segments and identifying each training data segment of the training data segments as corresponding to a normal operational state of the first oilfield equipment or a failed state of the first oilfield equipment. The method also includes generating a shapelet-based decision tree and receiving a test data stream from a sensor of second oilfield equipment. The method further includes determining, based on the shapelet-based decision tree, whether one or more test data segments extracted from the test data stream predict a failure of the second oilfield equipment.

### CROSS-REFERENCE TO RELATED APPLICATIONS

The present application claims priority under 35 U.S.C. Section 119(e) to U.S. Provisional Patent Application No. 62/108,477, filed Jan. 27, 2015, and titled “Shapelet-Based Oilfield Equipment Failure Prediction and Detection,” the entire content of which is incorporated herein by reference.

### FIELD

The disclosure relates generally to detection and prediction of equipment failure, and in particular, to use of time series data shapelets to detect and/or predict equipment failure (e.g., oilfield equipment failure).

### BACKGROUND

In the oil/gas industry, sensors are typically used to measure oilfield equipment parameters. As the instrumentation of oilfield operations increases, large amounts of data are being collected from sensors that monitor operations of the equipment in the field. The data from some sensors may also be generated at a relatively high frequency, which further results in large amounts of data. The data streams from sensors associated with oilfield equipment may be analyzed to determine the state of the oilfield equipment. For example, in some cases, a data stream from a sensor associated with oilfield equipment may be analyzed to determine whether the oilfield equipment is not performing as expected, referred to as equipment failure. Inability to rapidly process data from oilfield sensors may result in loss of information that may be indicative or predictive of equipment failure. Therefore, a need exists in the art for an improved way to detect and/or predict equipment failure from the large amounts of data.

### SUMMARY

The present disclosure relates to detection and prediction of oilfield equipment failure. In an example embodiment, a method for predicting a failure of oilfield equipment based on univariate time series includes providing, by a sensor of first oilfield equipment, training data, where a training data stream comprising the training data is received by a preprocessor. The method further includes extracting, by the preprocessor, training data segments from one or more portions of the training data stream generated prior to the first oilfield equipment failing to operate normally. Portions of the training data in the one or more portions of the training data stream were sampled at a regular sampling rate. The method also includes identifying each training data segment of the training data segments as corresponding to a normal operational state of the first oilfield equipment or a failed state of the first oilfield equipment, where the failed state of the first oilfield equipment corresponds to the oilfield equipment failing to operate normally. The method also includes generating, by a processor, a shapelet-based decision tree, wherein generating the shapelet-based decision tree includes extracting one or more time series shapelets from one or more training data segments of the training data segments. The method further includes receiving a test data stream from a sensor of second oilfield equipment. The method further includes determining by the processor, based on the shapelet-based decision tree, whether one or more test data segments extracted from the test data stream predict a failure of the second oilfield equipment.

In another example embodiment, a system for predicting a failure of oilfield equipment based on univariate time series includes a data storage device to store and provide a training data stream generated by a sensor of first oilfield equipment. The system further includes a preprocessor to extract training data segments from one or more portions of a training data stream that include training data generated prior to the first oilfield equipment failing to operate normally. The training data in the one or more portions of the training data streams were sampled at a regular sampling rate. The preprocessor to identify each training data segment of the training data segments as corresponding to a normal operational state of the first oilfield equipment or a failure state of the first oilfield equipment. The failure state of the first oilfield equipment corresponds to the oilfield equipment failing to operate normally. The system also includes a processor to generate a shapelet-based decision tree by extracting one or more time series shapelets from one or more training data segments of the training data segments. The preprocessor receives a test data stream generated by a sensor of second oilfield equipment, and the processor determines, based on the shapelet-based decision tree, whether one or more test data segments extracted from the test data stream predict a failure of the second oilfield equipment.

In another example embodiment, a method of predicting a failure of oilfield equipment based on multivariate time series includes receiving multiple training data streams generated by multiple sensors of first oilfield equipment. The multiple training data streams are time-wise synchronized with each other. The method further includes extracting, by a preprocessor, training data segments from a portion of each training data stream of the multiple training data streams. The portion of each training data stream includes training sensor data generated prior to the first oilfield equipment failing to operate normally. The method also includes identifying each training data segment of the multiple training data segments as corresponding to a normal operational state of the first oilfield equipment or a failed state of the first oilfield equipment. The failed state of the first oilfield equipment corresponds to the first oilfield equipment failing to operate normally. Further, the method includes selecting a subset of training data streams from the multiple training data streams based on computed feature values of each training data segment of the multiple training data segments and based on identification of each training data segment as corresponding to the normal operational state of the first oilfield equipment or the failed state of the first oilfield equipment. Each training data stream of the subset of training data streams is generated by a respective sensor of a subset of the multiple sensors. The method also includes generating, by a processor, shapelet-based decision trees, wherein generating the shapelet-based decision trees includes extracting time series shapelets from training data segments extracted from the subset of the training data segments. The method further includes receiving test data streams from a subset of sensors of second oilfield equipment. Each sensor of the subset of the sensors of the second oilfield equipment measures the same parameter as a respective sensor of the subset of the multiple sensors of the first oilfield equipment. The method also includes determining, based on the shapelet-based decision trees, whether test data segments extracted from the test data streams predict a failure of the second oilfield equipment.

In yet another example embodiment, a method of predicting a failure of oilfield equipment based on multivariate time series includes concatenating, by a preprocessor, cut-size training data segments of multiple training data streams to generate a concatenated training data stream based on an order of a ranking of multiple sensors of first oilfield equipment, where the multiple training data streams are received from the multiple sensors of first oilfield equipment and where the multiple training data streams are time-wise synchronized with each other. The method further includes generating, by a processor, a shapelet-based decision tree, where generating the shapelet-based decision tree includes extracting one or more time series shapelets from the concatenated training data stream. The method also includes concatenating cut-size test data segments of test data streams in the order of the ranking of the multiple sensors of the first oilfield equipment to generate a concatenated test data stream, where the test data streams are received from sensor of second oilfield equipment. The method further includes determining by the processor, based on the shapelet-based decision tree, whether the concatenated test data stream predicts a failure of the second oilfield equipment.

These and other aspects, objects, features, and embodiments will be apparent from the following description and the appended claims.

### BRIEF DESCRIPTION OF THE DRAWINGS

Reference will now be made to the accompanying drawings, which are not necessarily drawn to scale, and wherein:

FIG. 1 illustrates an example time series shapelet extracted from a data segment of a stream of intake pressure measurement data generated by a sensor of an electrical submersible pump (ESP) according to an example embodiment;

FIG. 2 illustrates a system for detecting and predicting a failure of oilfield equipment based on univariate time series according to an example embodiment;

FIG. 3A illustrates training data segments extracted from a training data stream for use in performing failure detection of an ESP according to an example embodiment;

FIG. 3B illustrates training data segments extracted from a training data stream for use in performing failure prediction of an ESP according to an example embodiment;

FIG. 4 illustrates a method for predicting a failure of oilfield equipment based on univariate time according to an example embodiment;

FIG. 5 illustrates a system for detecting and predicting a failure of oilfield equipment based on multivariate time series according to an example embodiment;

FIG. 6 illustrates a method for predicting a failure of oilfield equipment based on multivariate time series according to an example embodiment; and

FIGS. 7A and 7B illustrate a method for predicting a failure of oilfield equipment based on concatenated data stream generated from multivariate time series data streams according to an example embodiment. The drawings illustrate only example embodiments and are therefore not to be considered limiting in scope. The elements and features shown in the drawings are not necessarily to scale, emphasis instead being placed upon clearly illustrating the principles of the example embodiments. Additionally, certain dimensions or placements may be exaggerated to help visually convey such principles. In the drawings, reference numerals designate like or corresponding, but not necessarily identical, elements.

### DETAILED DESCRIPTION OF THE EXAMPLE EMBODIMENTS

Those of ordinary skill in the art will appreciate that the embodiments in this disclosure, including the accompanying material, should not limit the scope of the claims attached hereto. Any examples set forth in this disclosure are not intended to be limiting and merely set forth some of the many possible embodiments for the claims. Furthermore, those of ordinary skill in the art will appreciate that some of the terminology in this disclosure is used for simplicity and should not limit the scope of the claims. For example, the terminology “oil/gas” is used for simplicity, but can include practically any hydrocarbon. Furthermore, the terminology “oilfield equipment” is used for simplicity, but this terminology may include practically any equipment used for hydrocarbon production (e.g., equipment used for oil production, equipment used for gas production, equipment used for both oil and gas production, equipment at a field, equipment that is above-surface, equipment that is subsurface, etc.). Hydrocarbon production can include actual hydrocarbon production (e.g., after first oil) as well as hydrocarbon exploration or pre-production (e.g., before first oil). Furthermore, this disclosure can even be applied to equipment that is not related to hydrocarbon production.

Increasing instrumentation of oilfields produces streams of data from sensors that monitor the operation of oilfield equipment in the field. For example, sensors may be used to monitor operations of oilfield equipment such as Electrical Submersible Pumps (ESPs), gas compressors, etc. To illustrate, sensors may continually measure electrical properties of the pump and provide streams of sensor data, which may be stored and/or processed onsite or relayed to another location (e.g., central location, above-surface location, etc.).

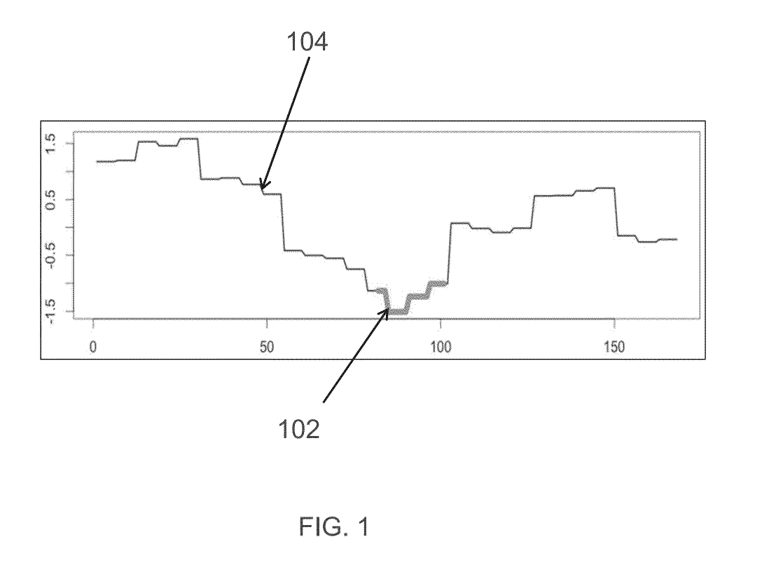

A time-series based method and system may be used to perform failure detection and/or failure prediction of the oilfield equipment based on streams of sensor data. To illustrate, time series shapelets, which are short instances that are particularly distinct in a stream of sensor data, may be used to detect and/or predict an oilfield equipment failure. FIG. 1 illustrates an example time series shapelet 102 extracted from a data segment 104 of a stream of intake pressure measurement data generated by a sensor of an electrical submersible pump (ESP) according to an example embodiment. The time series shapelet 102 was identified through a time series shapelet extraction method as being most discriminative for distinguishing a failed ESP from a normally operating ESP.

As described below, time series shapelets such as 102 can be used for detecting failures by comparing the time series shapelets against real-time sensor data. Time series shapelets are discriminative subsequences in time series which can differentiate instances of one class (e.g., normal operation of pump) from another class (e.g., failed or anomalous operation of pump). Time series shapelets are described in more detail in “Time series shapelets: a new primitive for data mining,” Lexiang Ye and Eamonn Keogh, Eamonn, Proceedings of the 15th ACM SIGKDD international conference on Knowledge discovery and data mining, pages 947-956, 2009, ACM, the entire content of which is incorporated herein by reference and referred to as Ye hereinafter.

Time series shapelets are extracted based on information gain criteria as described in Ye. A subsequence of a time series (i.e., a temporal data stream) with the highest information gain is identified to be the most discriminative among the classes and extracted as a “time series shapelet.” To perform classification of new time series (e.g., a new segment of data) using extracted shapelets, a decision tree is generated based on a distance (e.g., Euclidean distance) from a time series shapelet. To classify a data segment of a data stream using the decision tree, the distance between the new data segment and the time series shapelet is calculated. Depending on which branch of the decision tree the new data segment falls under (i.e., depending whether the distance is lesser or greater than distance measure of the time series shapelet), the new data segment is assigned a class label. A decision tree with multiple nodes can be generated and used in a similar manner when multiple time series shapelets can be extracted from a data stream.

Based on information (e.g., times of failed/abnormal or normal operations of an ESP), a shapelet extraction method can be used to identify/extract from a stream of sensor data one or more data segments (or sub-segments) as time series shapelets, which are most discriminative for classifying new data segments among two classes, such as data segments associated with failed/likely to fail (i.e., detection/prediction) oilfield equipment and normally operating oilfield equipment. A time series shapelet extraction method, referred to as “Fast Shapelets” method hereinafter, is described in “Fast shapelets: A scalable algorithm for discovering time series shapelets,” T. Rakthanmanon and E. Keogh, Proceedings of the thirteenth SIAM conference on data mining (SDM), 2013, the entire content of which is incorporated herein by reference. Thus, using time series shapelets extracted from historical data, detection and/or predictions about future failures or anomalies can be made, which can enable proactive steps to be taken.

Use of time series shapelets to detect and/or predict failures of oilfield equipment can enable fast failure detections and predictions because the failure detections and predictions are performed on new sensor data streams based on the shapelets, which are generally a small fraction of the size of the historical data. The ability to quickly detect equipment failures and/or to predict equipment failures may increase safety, improve hydrocarbon production efficiency, and reduce equipment downtime. For example, efficient processing of large amounts of sensor data to perform detection and/or prediction of equipment failure efficiently may potentially result in improved productivity by enabling, for example, better maintenance scheduling. Furthermore, the approach discussed herein is particularly applicable to large oil/gas enterprise datasets (and the like) because the approach does not need access to the entire historical data, which greatly reduces the amount of data that needs to be stored for data analysis. Moreover, unlike model-based approaches, the shapelet-based approached herein does not make any assumptions about the underlying nature of the data, making it practical where a detailed physical model (e.g., of the ESP) is not available.

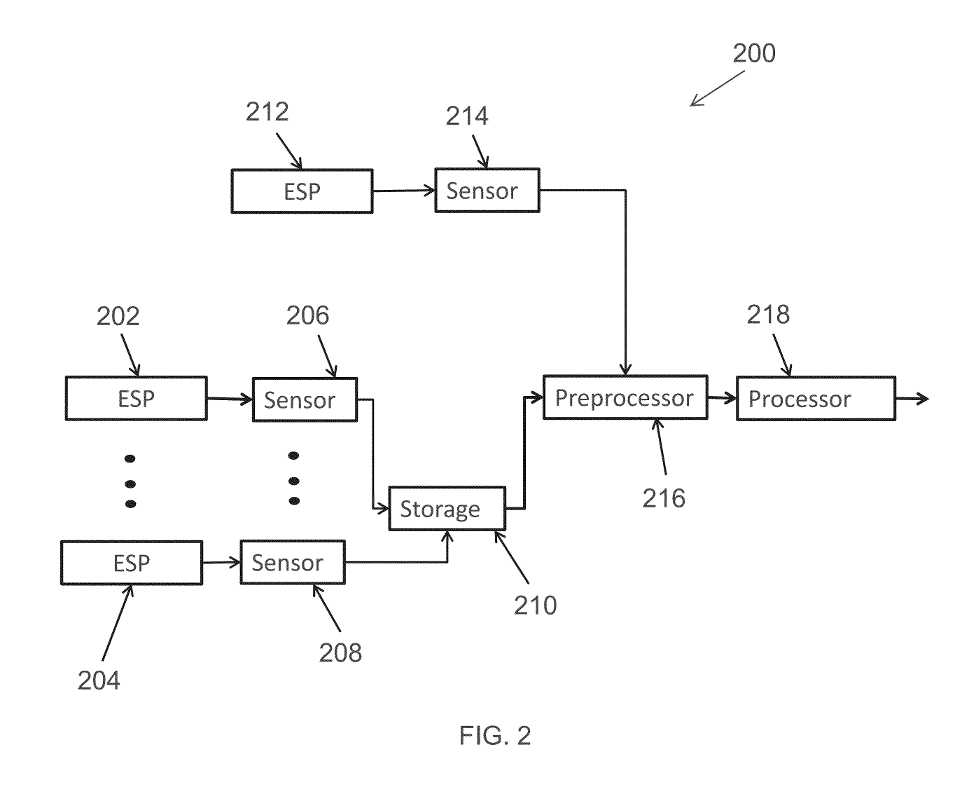

FIG. 2 illustrates a system for detecting and predicting a failure of oilfield equipment based on univariate time series according to an example embodiment. The system 200 includes electrical submersible pumps (ESPs) 202, 204. The system 200 may also include sensors 206, 208 that generate data streams (training data stream) by measuring/sensing some parameters of the ESPs 202, 204. The sensors 206, 208 may measure/sense a parameter such as current, voltage, or intake pressure of the ESPs 202, 204. In some example embodiments, the system 200 also includes storage device 210. For example, the training data streams generated by the sensors 206, 208 may be stored in the storage device 210.

Information that indicate/enable identification of portions of the training data streams that are generated when the ESPs 202, 204 are operating in a normal state or in a failed state (i.e., data generated while the ESP 202, 204 had failed to operate normally) may also be stored in the storage device 210. Timing information (e.g., timestamps) associated with the training data streams may also be stored in the storage device 210. To illustrate, the sensors 206, 208 may measure/sense the parameters of the ESPs 202, 204 at one interval for a duration of time and at another interval for another duration of time. For example, the sensors 206, 208 may sample the parameters from the ESPs 202, 204 at an interval of once per day during one week and at a different interval during another week. Further, timing information identifying the entry time (e.g., date and hour) of the training data stream into the storage device 210 may be included in the storage device 210. Also, timing information for use in identifying invalid data in the training data streams may be stored in the storage device 210. For example, invalid data may be a result of a failed sensor.

The system 200 further includes an ESP 212 and a sensor 214 that generates a data stream (test data stream) by measuring/sensing a parameter—current, voltage, or intake pressure—of the ESP 212. The system 200 may be used to make failure detection and prediction of the ESP 212 based on shapelet-based decision tree generated from the training data streams provided by the sensors 206, 208.

In some example embodiments, the system 200 also includes a preprocessor 216 and a processor 218. In some example embodiments, one or more of the preprocessor 216 and the processor 218 may be implemented using hardware (e.g., a microprocessor, FPGA, . . . ), software, or a combination of hardware and software. To perform a failure detection of the ESP 212 by the system 200, the preprocessor 216 extracts training data segments from one or more portions of the training data streams generated by the sensor 206 that include training data generated by the sensor 206 during a time duration that the ESP 202 failed to operate normally and that do not include training data generated by the sensor 206 during a time duration that the ESP 202 was operating normally. Information about the normal and failed states of the ESPs 202, 204 may be received by the preprocessor 216 from the storage device 210. The training data segments extracted in such a manner are identified as corresponding to a normal operational state of the ESP 202. The preprocessor 216 also extracts training data segments from one or more portions of the training data streams generated by the sensor 206 during a time duration that the ESP 202 was operating normally and that do not include training data generated by the sensors 206 during a time duration that the ESP 202 failed to operate normally. The training data segments extracted in such a manner are identified as corresponding to a normal operational state of the ESP 202. In general, the preprocessor 216 identifies each training data segment of the training data segments as corresponding to a normal operational state of the ESP 202 or a failed state of the ESP 202. The failure state of the ESP 202 corresponds to the ESP 202 failing to operate normally. The preprocessor 216 can extract training data segments from other training data streams generated by other ESPs of the system 200 including the ESP 204. Although the system 200 of FIG. 2 is described as including ESPs, in other example embodiments, the system 200 may include other oilfield equipment (e.g., gas compressors) or non-oilfield equipment without departing from the scope of this disclosure.

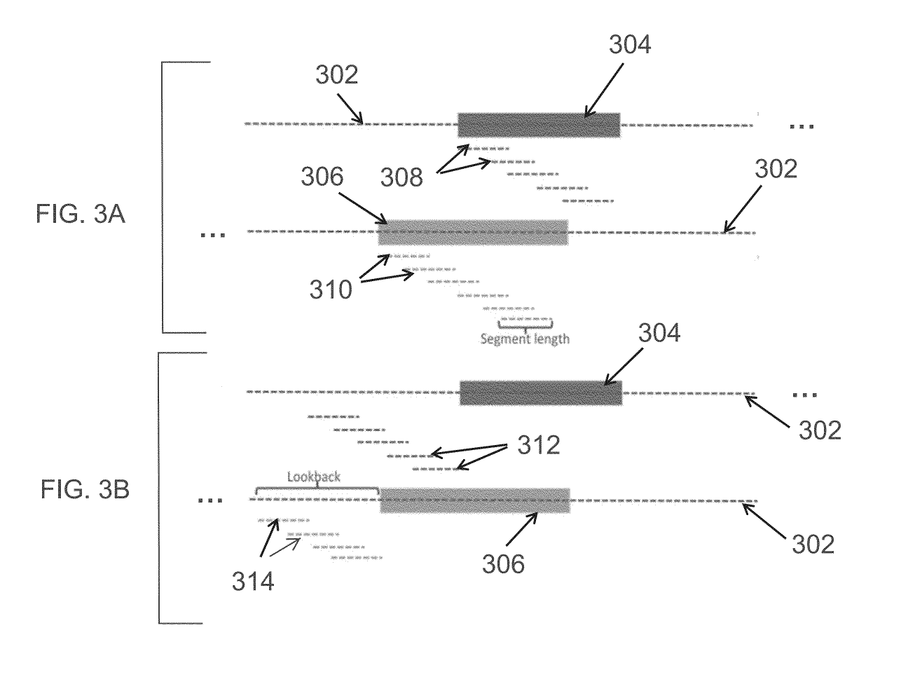

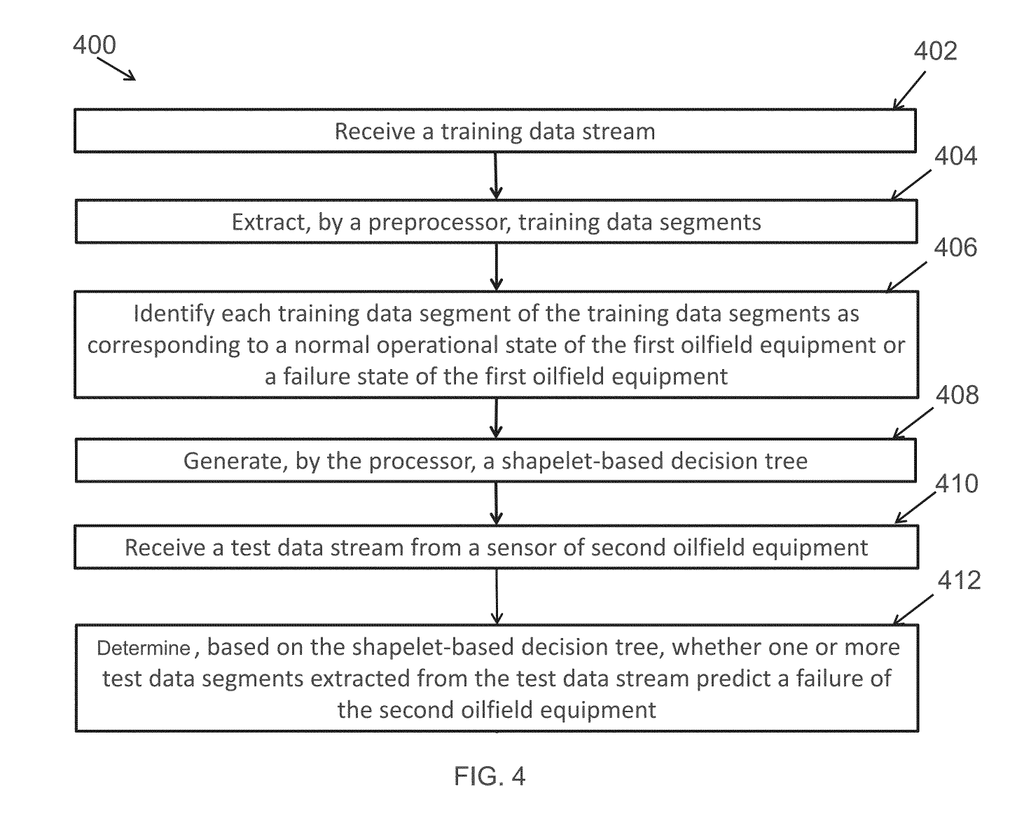

FIG. 3A illustrates training data segments 308, 310 extracted from a training data stream 302 for use in performing failure detection of the ESP 212 according to an example embodiment. Referring to FIGS. 2 and 3A, the training data stream 302 may be generated, for example, by the ESP 202. Portions of the training data stream that correspond to the ESP 202 failing to operate normally are shown in the shaded box 304. Portions of the training data stream that correspond to the ESP 202 in a normal operational state are shown in the shaded box 306. Training data segments 308 are extracted from the portions of the training data stream 302 in the shaded box 304 and are identified corresponding to the failed state of the ESP 202. Training data segments 310 are extracted from the portions of the training data stream 302 in the shaded box 306 and are identified corresponding to the normal operational state of the ESP 202. Training data streams from other ESPs such as the ESP 204 that may be used to generate training data streams may be processed by the preprocessor 216 in a similar manner.

To perform a failure prediction of the ESP 212 instead of failure detection of the ESP 212, the preprocessor 216 can extract training data segments from one or more portions of the training data streams generated by the sensor 206 that include training data generated close but prior to the ESP 202 failing to operate normally and do not include training data from other portions of the training data segments. The training data segments extracted in such a manner are identified/designated as corresponding to a failed state of the ESP 202. The preprocessor 216 also extracts training data segments from one or more portions of the training data streams generated by the sensor 206 that include training data generated close and prior to a duration time during which the ESP 202 operated normally and that do not include training data from other portions of the training data segments. The training data segments extracted in such a manner are identified/designated as corresponding to a normal operational state of the ESP 202. The identification/designation of training data segments is used by the processor 210 in generating the shapelet-based decision tree.

FIG. 3B illustrates training data segments 312, 314 extracted from a training data stream 302 for use in performing failure prediction of the ESP 212 according to an example embodiment. Referring to FIGS. 2, 3A, and 3B, the training data stream 302 may be generated, for example, by the ESP 202. Portions of the training data stream that correspond to the ESP 202 failing to operate normally are shown in the shaded box 304. Portions of the training data stream that correspond to the ESP 202 in a normal operational state are shown in the shaded box 306. Training data segments 312 are extracted from the portions of the training data stream 302 in the shaded box 304 and are identified/designated corresponding to the failed state of the ESP 202. Training data segments 314 are extracted from the portions of the training data stream 302 in the shaded box 306 and are identified/designated as corresponding to the normal operational state of the ESP 202. Training data streams from other ESPs such as the ESP 204 that may be used to generate training data streams may be processed by the preprocessor 216 in a similar manner. The preprocessor 216 identifies each training data segment of the training data segments as corresponding to a normal operational state of the ESP 202 or a failed state of the ESP 202. The identification/designation of training data segments is used by the processor 210 in generating the shapelet-based decision tree.

In some example embodiments, the preprocessor 216 extracts the training data segments from portions of the training data stream that include only training data that were sampled at a regular sampling rate. To illustrate, prior to extracting the training data segments, the preprocessor 216 may identify one or more portions of the training data stream from the ESP 202 that are were sampled at a desired sampling rate based on the timing information stored in the storage device 210. For example, a portion of the training data may have been generated by the sensor 206 at a rate of 1 hour while another portion of the training data may have been generated by the sensor 206 at a rate of 5 hours. The preprocessor 216 can distinguish from the different portions based on timing information (e.g., timestamps or other information) and choose to the portion of the training data stream that has training data generated, for example, at the rate of 1 hour.

In some example embodiments, the preprocessor 216 may extract the training data segments only from portions of the training data stream from the ESP 202 that do not include invalid data (invalid data referring to, for example, training data generated while the sensor was malfunctioning) based on information (e.g., timing or other information) that is provided along with the training data stream. The preprocessor 216 may also consider training data stored in the storage device a long time (e.g., over 1 day) after generation of the training data stream by the sensor 206 as invalid and exclude portions of the training data stream that include such data.

Referring to FIGS. 2, 3A, and 3B, the preprocessor 216 may extract the training data segments 308 such that adjacent one of the data segments 308 overlap with each other. The adjacent data segments of the data segments 310, 312, 314 may also overlap in a similar manner. The preprocessor 216 may perform the extraction of the training data segments 308, 310, 312, 314 such that the overlap between adjacent training data segments is adequate to reduce unwanted redundancy of the data between adjacent training data segments without losing the successful extraction of one or more time series shapelets from the training data segments. As a non-limiting example, the overlap between adjacent training data segments may be set or limited to a maximum of about 75%. Further, the length of the training data segments 308, 310, 312, 314 may be set to allow successful extraction of one or more time series shapelets from the training data segments. The maximum length of a time series shapelet that is extracted from a particular training data segment is the length of the training data segment.

Referring to FIGS. 2 and 3B, the size of a lookback widow that designates portions of the training data stream 302 from which to extract the training data segments for the purpose performing failure prediction by the processor 218 may be selected such that an adequate number of training data segments are extracted for a successful extraction of one or more time series shapelets. The size of the lookback window may be determined through empirical analysis. For example, the lookback window may be, for example, 1 week.

Referring to FIG. 2, once the training data segments are extracted as described above, the processor 218 generates a shapelet-based decision tree by extracting one or more time series shapelets from one or more training data segments of the training data segments. For example, the processor 218 may perform the Fast Shapelets method to extract one or more time series shapelets and to generate a shapelet-based decision tree for use in either failure detection or failure prediction. The processor 218 may generate a shapelet-based decision tree based on data segments that are extracted from multiple training data streams from multiple sensors 206, 208, and others as long as the multiple training data streams include the same parameter (e.g., voltage of ESP 202, 204, and others). The processor 218 generates a shapelet-based decision tree for failure detection based on the one or more shapelets extracted from data segments generated for the purpose of failure detection as described above with respect to FIG. 3A. The processor 218 generates a shapelet-based decision tree for failure prediction based on the one or more shapelets extracted from data segments generated for the purpose of failure prediction as described above with respect to FIG. 3B.

To perform failure prediction of the ESP 212, the preprocessor 216 (or another preprocessor, for example, when the decision tree generation and failure prediction are performed at separate locations) receives a test data stream from the sensor 214. Alternatively, the test data stream may be provided to the preprocessor 216 from a temporary storage device. The test data stream includes test data for the same parameter (e.g., voltage of the ESP) as the training data of the training data stream(s) used in the generation of the shapelet-based decision tree. The processor 218 (or another processor) determines, based on the shapelet-based decision tree generated for failure prediction, whether one or more test data segments extracted from the test data stream predict a failure of the ESP 212.

In some example embodiments, the test data segments of the test data stream may be extracted by the preprocessor 216 (or another preprocessor) in a similar manner described above with respect to the training data segments without specific knowledge of test data portions that may correspond to normal or failed operation of the ESP 212. For example, the preprocessor 216 may extract the test data segments from portions of the test data stream that are sampled at the same rate as the training data stream portions selected for training data segment extraction. Further, portions of invalid data in the test data stream may be excluded. The amount of overlap between adjacent data test data segments is also selected to match the amount of overlap between adjacent training data segments described above.

In some example embodiments, once the test data segments are generated, the processor 218 determines whether the one or more test data segments predict the failure of the ESP 212 based on the shapelet-based decision tree by determining Euclidean distances between each test data segment and the one or more time series shapelets generated by the processor 218 based on the training data segments. In some alternative embodiments, distances other than Euclidean distances may be used.

In some example embodiments, the processor 218 indicates a prediction of the failure of the ESP 212 if a ratio of a number of test data segments that predict the failure of the second oilfield equipment to a total number of the one or more test data segments checked based on the shapelet-based decision tree exceeds a threshold. As a non-limiting example, if twenty percent of test data shapelets predict a failure of the ESP 212, the processor 218 may generate an output indicating the prediction of failure. Otherwise, the processor 218 may indicate prediction of non-failure of the ESP 212.

In some example embodiments, failure detection of the ESP 212 may be performed in a similar manner based on shapelet-based decision tree that is generated based on time series shapelets extracted from training data segments extracted for failure detect as described above. Description of failure prediction and detection are described in “Predicting Failures from Oilfield Sensor Data using Time Series Shapelets,” Om Prasad Patri et al., SPE-170680-MS, Society of Petroleum Engineers, 2014, the entire content of which is incorporated herein by reference.

In some example embodiments, a pair of preprocessor and processor may be used to generate the decision tree and another pair of preprocessor and processor may be used to perform failure detection and prediction based on the decision tree. In some example embodiments, the system may have only one ESP (e.g., ESP 202) that is used to generate training data streams or may have more than two (e.g., 10). Further, the system 200 may perform failure detection on ESPs other than the ESP 212. In some example embodiments, the processor and the preprocessor may be the same device. Although some operations are described above with respect to ESP 202, the operations may be performed with respect to other ESPs such as the ESP 204 in a similar manner. Further, although sensors and ESPs are shown in FIG. 2 as separate components, in alternative embodiments, some or all of the sensors may be part of the ESPs.

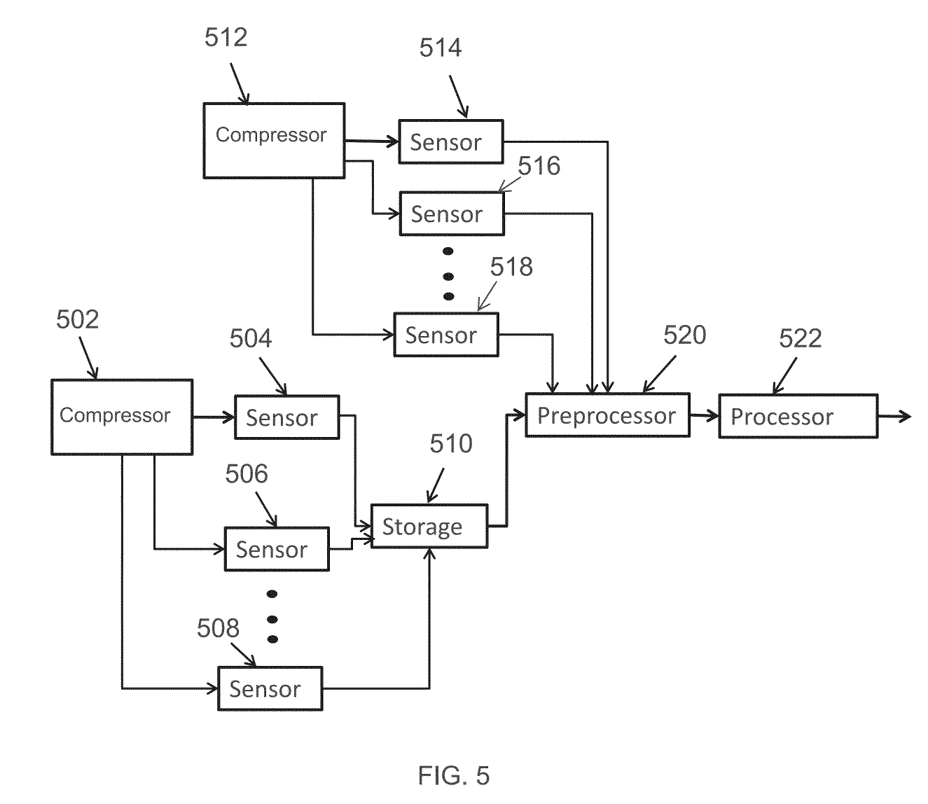

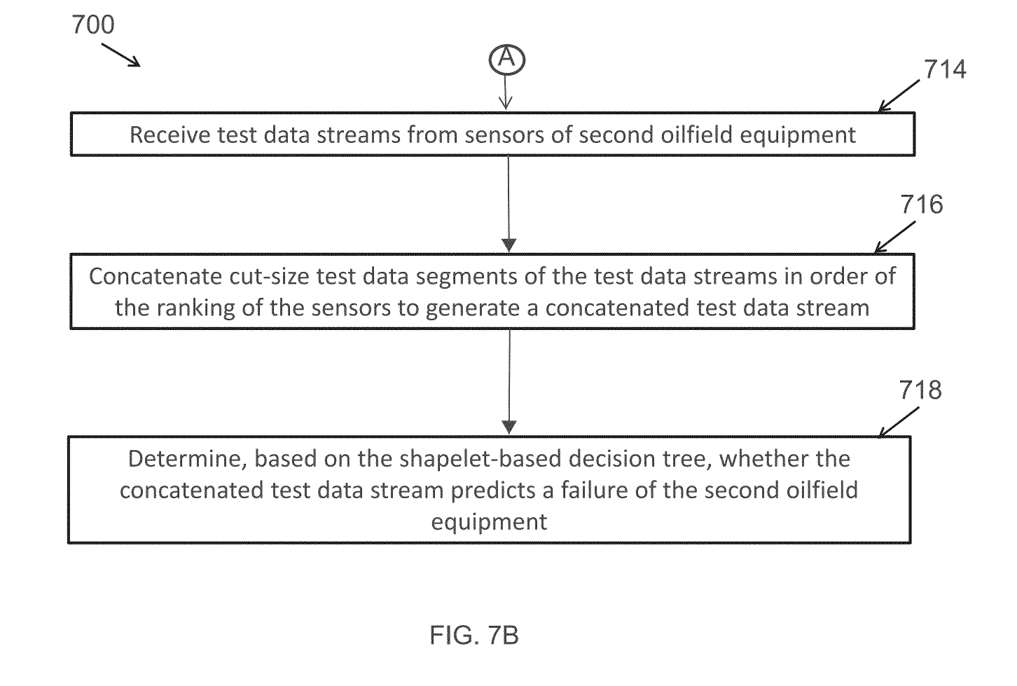

FIG. 4 illustrates a method 400 for predicting a failure of oilfield equipment based on univariate time series according to an example embodiment. Referring to FIGS. 2 and 4, in some example embodiments, the method 400 includes receiving a training data stream generated by a sensor (e.g., the sensor 206) of first oilfield equipment (e.g., the ESP 202), at 402. The method 400 may also include receiving other training data streams generated by other sensors (e.g., the sensor 208) of other oilfield equipment (e.g., the ESP 204). For example, the preprocessor 216 may receive the data from a storage device (e.g., the storage device 210) that contains training data streams generated by the first oilfield equipment (e.g., ESP 202) and other oilfield equipment (e.g., ESP 204). At step 404, the method includes extracting, by a preprocessor (e.g., the preprocessor 216), training data segments from one or more portions of the training data stream generated prior to the first oilfield equipment failing to operate normally. For example, the training data segments may be extracted as described in connection with FIG. 7 of the following paper “Predicting Failures from Oilfield Sensor Data using Time Series Shapelets,” Om Prasad Patri et al., SPE-170680-MS, Society of Petroleum Engineers, 2014, the entire content of which is incorporated herein by reference. As described above with respect to FIG. 2, the training data in the one or more portions of the training data stream were sampled at a regular sampling rate (e.g., the sensor 206 measuring voltage of the ESP 202 at a rate of every 1 hour).

At step 406, the method 400 includes identifying/designating each training data segment of the training data segments as corresponding to a normal operational state of the first oilfield equipment or a failed state of the first oilfield equipment. For example, the preprocessor 216 may identify the training data segments of training data streams generated by the sensors 206, 208, and other ESPs as described above with respect to FIG. 2. To illustrate, each training data segment of the training data segments is identified as corresponding to the normal operational state of the first oilfield equipment or the failure state of the first oilfield equipment based on information identifying a portion of the training data stream that is generated by the sensor of first oilfield equipment while the first oilfield equipment was in the failed state. The failed state of the first oilfield equipment corresponds to the oilfield equipment failing to operate normally. Classification of a normal operation state or a failed state is described further in connection with FIGS. 3A-3B.

At step 408, the method 400 includes generating, by a processor (e.g., the processor 218), a shapelet-based decision tree. The processor may generate the shapelet-based decision tree by extracting one or more time series shapelets from one or more training data segments of the training data segments in a manner described above with respect to the processor 218. The identification/designation of training data segments is used in generating the shapelet-based decision tree. The generated shapelet-based decision tree can be used to predict failure of another oilfield equipment (e.g., the ESP 212) as described above with respect to FIG. 2. In some example embodiments, extracting the one or more time series shapelets from the one or more training data segments of the training data segments is performed by the processor using the Fast-Shapelet method (as in “Fast shapelets: A scalable algorithm for discovering time series shapelets,” T. Rakthanmanon and E. Keogh, Proceedings of the thirteenth SIAM conference on data mining (SDM), 2013). After the one or more time series shapelets have been extracted, then the shapelets based decision tree may be generated (as in “Fast shapelets: A scalable algorithm for discovering time series shapelets,” T. Rakthanmanon and E. Keogh, Proceedings of the thirteenth SIAM conference on data mining (SDM), 2013).

At step 410, the method 400 includes receiving (e.g., by the preprocessor 216) a test data stream from a sensor (e.g., the sensor 214) of second oilfield equipment (e.g., the ESP 212). At step 412, the method 400 includes determining, based on the shapelet-based decision tree, whether one or more test data segments extracted from the test data stream predict a failure of the second oilfield equipment (e.g., ESP 212). The one or more test data segments are extracted from one or more portions of the test data stream. For example, the processor 218 may determine whether one or more test data segments extracted from the test data stream predict a failure of the ESP 212. The test data in the one or more portions of the test data stream were sampled at the same sampling rate as the training data in the training data segments used to generate the time series shapelets. As described above, determining whether the one or more test data segments predict the failure of the second oilfield equipment (e.g., ESP 212) based on the shapelet-based decision tree includes determining Euclidean distances between each test data segment of the one or more test data segments and the one or more time series shapelets. As described with respect to FIG. 2, the training data stream (e.g., from sensor 206) used to generate the decision tree and the testing data stream (e.g., from sensor 214) correspondingly includes voltage data, current data, or intake pressure data.

In some example embodiments, the method 400 includes predicting the failure of the second oilfield equipment (e.g., the ESP 212) if a ratio of a number of test data segments of the one or more test data segments that predict the failure of the second oilfield equipment to a total number of the one or more test data segments processed based on the shapelet-based decision tree exceeds a threshold. For example, the threshold may be a value determined based on empirical analysis.

In some example embodiments, the method 400 excludes a portion of the training data stream that includes invalid data in extracting the training data segments from the one or more portions of the training data stream includes. The method 400 may also include extracting the training data segments such that two consecutive/adjacent data segments have overlapping data portions and non-overlapping data portions, wherein the overlapping data portions are less than a threshold percentage of the length of the training data segments (e.g., about 75%).

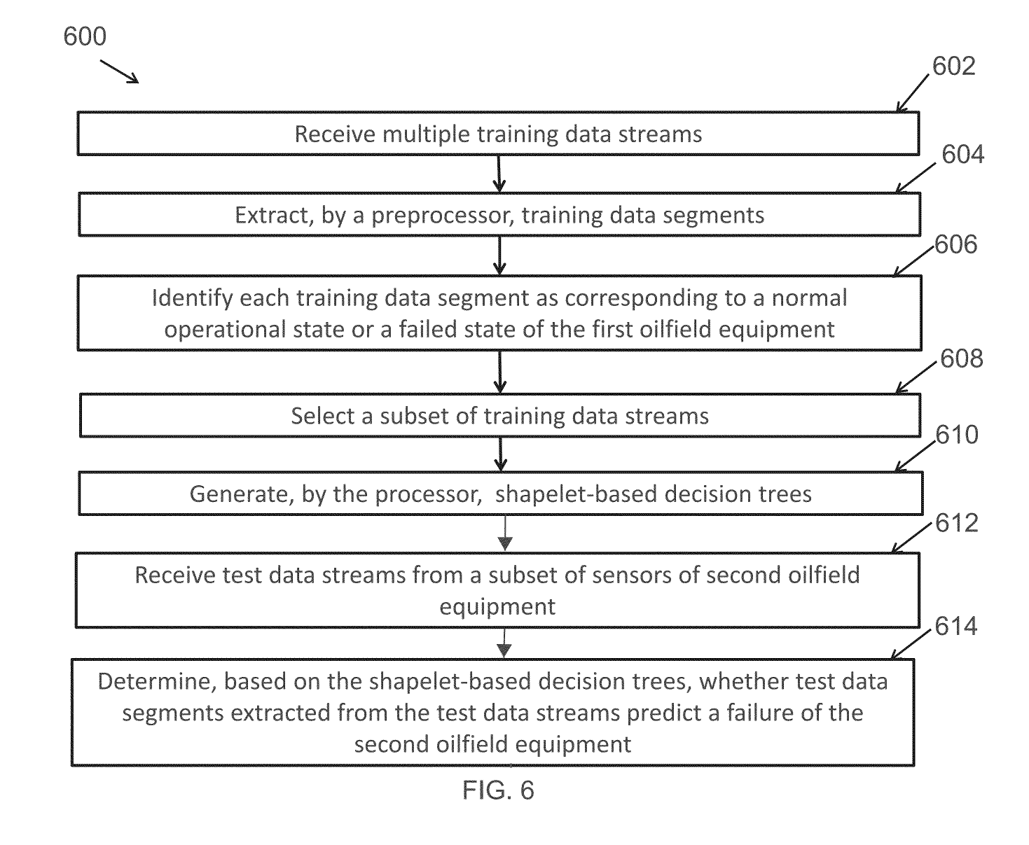

FIG. 5 illustrates a system 500 for detecting and predicting a failure of oilfield equipment based on multivariate time series according to an example embodiment. The system 500 includes gas compressors 502, 512. The system 500 includes sensors 504, 506, . . . , 508 that generate data streams (training data stream) by measuring/sensing some parameters of the gas compressor 502. The sensors 504, 506, . . . , 508 may measure/sense a parameter such as compressor vibrations, motor winding temperatures, and pressure and temperature for both suction and discharge at the various compression stages of the compressor 502. The system 500 may be operated to first rank the sensors 504, 506, . . . , 508 and use training data streams only from the sensors selected based on the ranking to generate decision trees for the purpose of predicting failure of the gas compressor 512.

In some example embodiments, the system 500 also includes storage device 510. For example, the training data streams generated by the sensors 504, 506, . . . , 508 may be stored in the storage device. The generation of the training data streams by the sensors 504, 506, . . . , 508 is synchronized so that the different training data streams from the different sensors 504, 506, . . . , 508 are synchronized with each other and correspond to the same state of the gas compressor 502.

In some example embodiments, information that indicate/enable identification of portions of the training data streams that are generated when the gas compressor 502 is operating in a normal state or in a failed state (i.e., data generated while the gas compressor 502 had failed to operate normally) may also be stored in the storage device 510. Timing information (e.g., timestamps) associated with the training data streams may also be stored in the storage device 510 similar to the manner described with respect to FIG. 2. Further, in some example embodiments, additional information identifying the entry time (e.g., date and hour) of the training data streams into the storage device 510 may be included in the storage device 510. Also, any other information that may be used in identifying invalid data in the training data streams may be stored in the storage device 510.

The system 500 further includes sensors 514, 516, . . . , 518 that generate data streams (test data streams) by measuring/sensing parameters of the gas compressor 512 such as compressor vibrations, motor winding temperatures, and pressure and temperature for both suction and discharge at the various compression stages of the compressor 512. The system 500 may be used to make failure prediction of the gas compressor 512 based on shapelet-based decision trees generated from the training data streams generated by some of the sensors 504, 506, . . . , 508.

In some example embodiments, the system 500 also includes a preprocessor 520 and a processor 522. In some example embodiments, one or more of the preprocessor 520 and the processor 522 may be implemented using hardware (e.g., a microprocessor, FPGA, . . . ), software, or a combination of hardware and software. For each training data stream from the sensors 504, 506, . . . , 508, the preprocessor 520 extracts respective data segments in a manner similar to the extraction of training data segments described with respect to the preprocessor 216 of FIG. 2. For example, for performing a failure prediction of the gas compressor 512, the preprocessor 520 can extract training data segments from one or more portions of each training data stream generated by the sensor 504, 506, 508 that include training data generated close but prior to the compressor 502 failing to operate normally and that do not include training data from other portions of the training data segments. The training data segments extracted in such a manner are identified/designated as corresponding to a failed state of the compressor 502.

The preprocessor 520 also extracts respective training data segments from one or more portions of each training data stream generated by the sensors 504, 506, . . . , 508 that include training data generated close and prior to a duration time during which the compressor 502 operated normally and that do not include training data from other portions of the training data segments. The training data segments extracted in such a manner are identified/designated as corresponding to a normal operational state of the compressor 502. The identification/designation of training data segments is used by the processor 522 in generating the shapelet-based decision tree.

Once the training data segments are extracted as described above, the processor 522 performs sensor and/or training data stream selection to select some of the sensors 504, 506, . . . , 508 and/or corresponding training data streams that are used to extract times series shapelets and to generate shapelet-based decision trees that are used to perform failure prediction of the gas compressor 512. Training data streams from remaining one or more of the sensors 504, 506, . . . , 508 will not be used to generate decision trees. Further, particular sensors from among the sensors 514, 516, . . . , 518 of the gas compressor 512 that are used to generate test data streams for performing failure prediction of the gas compressor 512 are selected to correspond to the selected sensors from among the sensors 504, 506, . . . , 508. For example, if the training data stream from the sensor 504, which, for example, measures motor winding temperature, is used to generate a decision tree, a test data stream from the sensor 514, which also measures motor winding temperature, is used to generate test data segments for the purpose of performing failure prediction.

In order to identify the most relevant sensors for failure prediction from among the sensors 504, 506, . . . , 508, a single sensor classification accuracy value is computed for a number of features of each training data stream from the respective sensor 504, 506, . . . , 508. In some example embodiments, the computed features are a mean value, a missing data points, a mean slope, a ratio of measurements, and an exponential decay.

Mean value refers to the mean of each training data value, excluding any missing data points. The mean value is used as a feature because failures may be correlated with a decrease or increase in a particular parameter (e.g., vibration) from the parameter's normal value. Missing data points refers to using the number of missing data was included as a feature because of the possibility that the underlying failure of gas compressor either directly or indirectly affects the factors causing sensor measurements not to be recorded, including sensor malfunction and communication failures. Mean slope refers to using best fit straight line (minimizing the sum of least square distances) to the training data over a window period as a means of quantifying any down or up-trending in the measurements in the period before a failure. The slope of the best fit line is used as a feature.

Ratio of measurements refers using the mean ratio between every pair of temperature and pressure sensor data in order to determine if the ratio of two parameters (a nonlinear computation) over the window period is an indicator of failure. Exponential decay refers to selecting a characteristic sequence of exponentially falling temperature measurement and computing the cross-correlation of the pattern with the measurements from every sensor for an entire lookback period. The peak cross correlation value from each sensor is used as a feature. In an example embodiment, each of the above features may be computed for a 1 week window of training data streams with for example, for example, a two-minute resolution measurement data.

To illustrate computation of features with respect to sensors 504, 506, and 508, each sensor 504, 506, 508 outputs a respective training data stream such that the training data streams are synchronous with each other. In Table 1 below, data values of the training data streams generated by sensor 504 are designated a₁, a₂, . . . . Similarly, data values of the training data streams generated by sensor 506 are designated b₁, b₂, . . . and data values of the training data streams generated by sensor 508 are designated c₁, c₂, . . . .

The training data streams are shown as segmented into uniform length training data segments, for example, by the preprocessor 520. Each training data segment is also identified/designated as corresponding to a normal operational state of the gas compressor 502 or a failed state of the gas compressor 502 as indicated by the respective Y values in the Table 1. Because the training data streams are synchronized, respective training data segments have identical designation, where for each Y, (1) indicates failed and (0) indicates normal operation of the gas compressor 502. As a non-limiting example, the length of the training data segments of the training data streams is 10 as shown in Table 1.

TABLE 1

| | | | |
|---|---|---|---|
| 504₁ = a₅, a₆, . . . , a₁₄ | 506₁ = b₅, a₆, . . . , a₁₄ | 508₁ = c₅, c₆, . . . , c | Y₁ = 0 |
| 504₂ = a₂₀, a₂₁, . . . , a₃₀ | 506₂ = b₂₀, a₂₁, . . . , a₃₀ | 508₂ = c₂₀, c₂₁, . . . , c₃₀ | Y₂ = 0 |
| . | . | . | . |
| . | . | . | . |
| . | . | . | . |
| 504₁₀ = a₇₅, a₇₆, . . . , a₈₄ | 506₁₀ = b₇₅, b₇₆, . . . , b₈₄ | 508₁₀ = c₇₅, c₇₆, . . . , c₈₄ | Y₁₀ = 1 |

In some example embodiments, a feature function that converts each training data segment into a single value may be implemented. For example, applying the mean value function converts 504₁=(a₅, a₆, . . . , a₁₄) to 504₁^{mean}=(a₅+a₆+ . . . +a₁₄)/10.

For each feature, applying a specific feature function to the training data segments results in the classification sets (one for each sensor), where each set is a pair of feature value and the label. For example, the training data for sensor 504 is ((A₁^{mean},Y₁), (A₂^{mean},Y₂), . . . , (A₁₀^{mean},Y₁₀)).

A linear classifier can be used to calculate the average classification accuracy predicting the labels Yᵢ given only Aᵢ^{mean}. Classification accuracy varies from 0 (completely inaccurate) to 100% (perfect prediction), and 50% corresponds to the accuracy of a random classifier. In some example embodiments, training data streams that have average classification accuracy significantly greater than 50% are selected.

Based on the average classification accuracy produced by performing linear classification, training data streams with relatively higher average classification accuracy may be identified/select such that training data segments extracted from the selected training data streams are used to time series shapelets. To illustrate, a subset of the training data streams are selected, the processor 522 generates shapelet-based decision trees for each selected training data stream based the training data segments extracted from the respective training data stream. For example, the processor 522 may perform the Fast Shapelets method (as in “Fast shapelets: A scalable algorithm for discovering time series shapelets,” T. Rakthanmanon and E. Keogh, Proceedings of the thirteenth SIAM conference on data mining (SDM), 2013) to extract time series shapelets and to generate shapelet-based decision trees for use in failure prediction of the gas compressor 512.

To perform failure prediction of the gas compressor 512, the preprocessor 520 (or another preprocessor, for example, when decision tree generation and failure prediction are performed at separate locations) receives test data streams from the sensors 514, 516, . . . , 518 and discard or ignore test data streams that do not correspond to the training data streams selected based on the computed features described above. For each of the test data streams that are not discarded (i.e., selected test data streams), the preprocessor 520, the processor 522 or another processor may extract test data segments from the selected test data streams in a manner similar to the extraction of test data segments described with respect to FIG. 2.

Once the test data segments are generated, for each selected test data stream, the processor 522 determines whether the one or more test data segments predict the failure of the gas compressor 512 based on the shapelet-based decision trees. For example, for each selected test data stream, the processor 522 may determine whether the one or more test data segments predict the failure of the gas compressor 512 by determining Euclidean distances between each test data segment and the respective time series shapelets generated by the processor 522. In some alternative embodiments, distances other than Euclidean distances may be used.

Once the processor determines the prediction for the individual selected test data streams, the processor 522 may compute a majority based decision to indicate whether failure of the gas compressor 512 is predicted.

Additional details about the failure prediction described here are provided in “Predicting Compressor Valve Failures from Multi-Sensor Data,” Om Prasad Patri et al., SPE-174044-MS, Society of Petroleum Engineers, 2015, the entire content of which are incorporated herein by reference.

In some example embodiments, a pair of preprocessor and processor may be used to generate the decision trees and another pair of preprocessor and processor may be used to perform failure prediction based on the decision trees. In some example embodiments, the system 500 may have few or more components than shown in FIG. 5. Further, the system 200 may perform failure detection on a gas compressor other than the gas compressor 512. In some example embodiments, the processor and the preprocessor may be the same device. Although sensors and gas compressors are shown in FIG. 5 as separate components, in alternative embodiments, some or all of the sensors may be part of the gas compressors. Although the system 500 of FIG. 5 is described as including gas compressors, in other example embodiments, the system 500 may include other oilfield equipment (e.g., ESP) or non-oilfield equipment without departing from the scope of this disclosure.

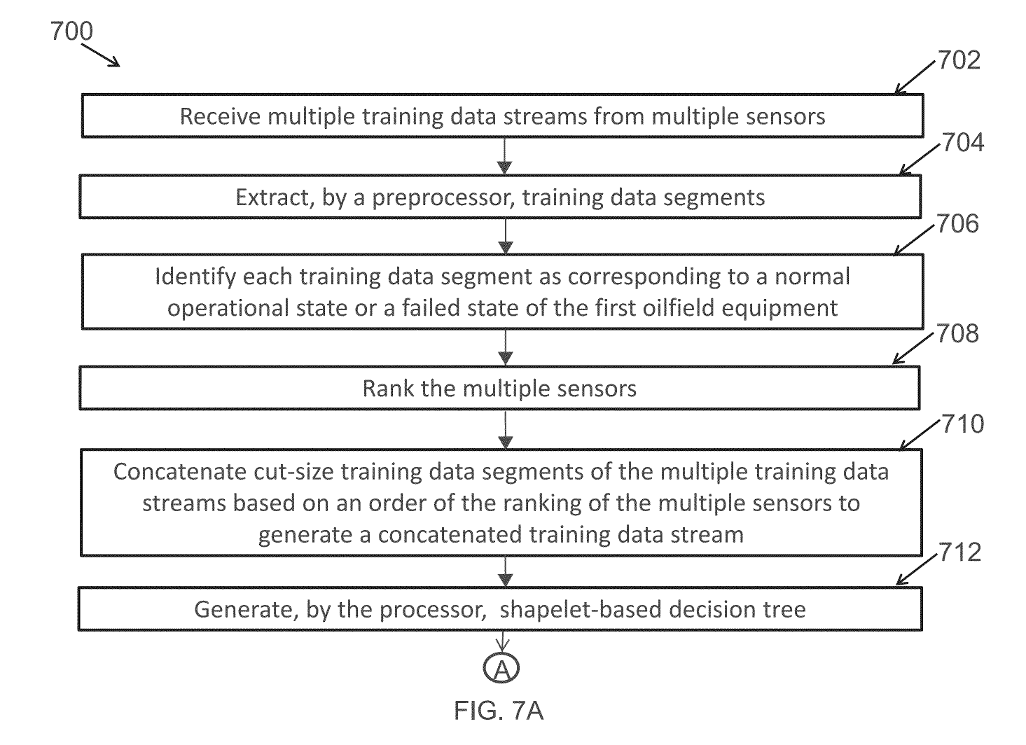

FIG. 6 illustrates a method 600 for predicting a failure of oilfield equipment based on multivariate time series according to an example embodiment. Referring to FIGS. 5 and 6, in some example embodiments, the method 600 includes receiving multiple training data streams generated by multiple sensors (e.g., sensors 504, 506, . . . , 508) of oilfield equipment (e.g., the gas compressor 502), at step 602. The multiple training data streams are time-wise synchronized (i.e, temporally synchronized) with each other. The method 600 may also include receiving other training data streams generated by other sensors of other oilfield equipment. At step 604, the method includes extracting, by a preprocessor (e.g., the processor 522), training data segments from a portion of each training data stream of the multiple training data streams. The portion of each training data stream includes respective training sensor data generated prior to the first oilfield equipment failing to operate normally. In some embodiments, step 604 may be similar to step 404 of FIG. 4

At step 606, the method 600 includes identifying/designating each training data segment of the multiple training data segments as corresponding to a normal operational state of the first oilfield equipment or a failed state of the first oilfield equipment. For example, the preprocessor 520 may identify each training data segment of the multiple training data streams generated by the sensors 504, 506, 508 as described above with respect to FIG. 5. To illustrate, each training data segment of the training data segments is identified as corresponding to the normal operational state of the first oilfield equipment (e.g., the gas compressor 502) or the failure state of the first oilfield equipment based on information identifying a portion of the training data stream that is generated by the sensor of first oilfield equipment while the first oilfield equipment was in the failed state. The failed state of the first oilfield equipment corresponds to the oilfield equipment failing to operate normally. In general, the training data segments are extracted from a respective one of the multiple training data streams and identified/designated in a manner similar to the training data segments described with respect to FIGS. 2, 3B, and 4. In some embodiments, step 606 may be similar to step 406 of FIG. 4

At step 608, the method 600 includes selecting a subset of training data streams from the multiple training data streams based on computed feature values of each training data segment of the multiple training data segments and based on identification of each training data segment as corresponding to the normal operational state of the first oilfield equipment or the failed state of the first oilfield equipment. Each training data stream of the subset of training data streams is generated by a respective sensor of a subset of the multiple sensors. In some example embodiments, selecting the subset of the training data streams from the multiple training data streams includes performing linear classifications of the computed feature values of each training data segment of the training data segments.

At step 610, the method includes generating, by the processor, shapelet-based decision trees. Generating the shapelet-based decision trees includes extracting time series shapelets from training data segments extracted from the subset of the training data segments. In some embodiments, step 610 may be similar to step 408 of FIG. 4. At step 612, the method includes receiving test data streams from a subset of sensors of second oilfield equipment (e.g., the gas compressor 512). Each sensor of the subset of the sensors 514, 516, . . . 518 of the second oilfield equipment 512 measures same parameter as a respective sensor of the subset of the multiple sensors 504, 506, . . . , 508 of the first oilfield equipment 502. At step 614, the method 600 includes determining, based on the shapelet-based decision trees, whether test data segments extracted from the test data streams predict a failure of the second oilfield equipment (e.g., the gas compressor 512). In some embodiments, step 614 may be similar to step 412 of FIG. 4. Although the method 600 is described with respect gas compressors, in other example embodiments, the method 600 may be applicable to systems with other oilfield equipment (e.g., ESP) or non-oilfield equipment without departing from the scope of this disclosure.

Those of ordinary skill in the art will appreciate that various modifications may be made to this disclosure. For example, a method of predicting a failure of oilfield equipment based on multivariate time series may be implemented as follows in some embodiments:
A. Training operations may include the following steps, where the inputs are a multivariate time series and time instances known to represent failures and where outputs are set of selected sensors, and shapelets and decision trees for every selected sensor. In some example embodiments, the training operations may include:
1. Pre-processing: Extract equal length (multivariate) segments and assign failure/normal labels to each from the time series based on the distribution of failure instances (select normal instances only from those periods that are not close to any failures and label segments as failures if they appear a short while before a failure time instance);
2. Feature selection: Compute a variety of features for each sensor stream in each segment. Specifically, the maximum cross-correlation with an exponential decay curve with a pre-defined magnitude and exponent can be used. Correlate the maximum cross-correlation feature for each sensor stream with the failure/normal labels using a linear classifier. Retain only sensor streams which have >50% classification accuracy; and
3. Apply univariate shapelet mining algorithm (specifically, Fast Shapelets) to only the sensor streams selected in Step 2. This step produces a set of shapelets and a decision tree for each selected sensor stream (much fewer than the total number of sensors).
B. Testing operations may include the following steps, where the input is a single multivariate time series and where outputs are classifications (e.g., Class A or Class B) indicating whether failure is predicted or not. In some example embodiments, the testing operations may include:
1. Discard variables from the multivariate time series that correspond to sensors not in the set of selected sensors;
2. For every selected sensor stream, compute the Euclidean distance to shapelets in the corresponding decision tree (from Step 3 of the training algorithm);
3. Use the distances to compute a failure/normal label using the decision tree for each selected sensor; and
4. Apply majority voting to select a single failure/normal label from the set of labels from selected sensors (from Step 3 of the training operations).

FIGS. 7A and 7B illustrate a method 700 for predicting a failure of oilfield equipment based on concatenated data stream generated from multivariate time series data streams according to an example embodiment. Referring to FIGS. 5, 7A and 7B, in some example embodiments, the method 700 includes receiving multiple training data streams generated by multiple sensors (e.g., sensors 504, 506, . . . , 508) of oilfield equipment (e.g., the gas compressor 502) at step 702. For example, the multiple training data streams may be the same as the training data streams received at step 602 of FIG. 6. To illustrate, the training data streams may have labels indicating portions of the training data streams as corresponding to normal operation state and failed state. The multiple training data streams are time-wise synchronized (i.e, temporally synchronized) with each other. The method 700 may also include receiving other training data streams generated by other sensors of other oilfield equipment. At step 704, the method includes extracting, by a preprocessor (e.g., the preprocessor 520), training data segments from a portion of each training data stream of the multiple training data streams. The portion of each training data stream includes respective training sensor data generated prior to the first oilfield equipment failing to operate normally. In some embodiments, step 704 may be similar to step 404 of FIG. 4 that is directed to a single data stream.

At step 706, the method 700 includes identifying/designating each training data segment of the multiple training data segments as corresponding to a normal operational state of the first oilfield equipment or a failed state of the first oilfield equipment. For example, the preprocessor 520 may identify each training data segment of the multiple training data streams generated by the sensors 504, 506, . . . , 508 as described above with respect to FIG. 5. To illustrate, each training data segment of the training data segments is identified as corresponding to the normal operational state of the first oilfield equipment (e.g., the gas compressor 502) or as corresponding to the failure state of the first oilfield equipment based on information associated with a portion of the training data stream that is generated by the sensor of first oilfield equipment while the first oilfield equipment was in the failed state. The failed state of the first oilfield equipment corresponds to the oilfield equipment failing to operate normally. In general, the training data segments are extracted from a respective one of the multiple training data streams and identified/designated in a manner similar to the training data segments described with respect to FIGS. 2, 3B, and 4. In some embodiments, step 706 may be similar to step 406 of FIG. 4.

At step 708, the method 700 includes ranking the multiple sensors (e.g., sensors 504, 506, . . . , 508). The ranking of the sensors may be performed in one of several ways. For example, the training data stream from each sensor 504, 506, . . . , 508 may be split into a validation set and a reduced training set, where the validation set is used to determine the accuracy of oilfield equipment failure prediction based on the reduced training set. Because the training data streams from the sensors (e.g., sensors 504, 506, . . . , 508) are associated with labels indicating normal operation state and failed state of the oil field equipment (e.g., compressor 502), the accuracy of failure prediction for each sensor (i.e., data stream from each sensor) may be determined based on the training data stream from the sensor. For example, the method 400 of FIG. 4 may be implemented to determine the accuracy of failure prediction for each sensor (i.e., data stream from each sensor).

For example, for each sensor 504, 506, . . . , 508, the method 400 of FIG. 4 may be performed using the reduced training set at step 404 and using the validation set at step 410 to determine the accuracy of failure prediction for the particular sensor. Once accuracy of failure prediction is performed for the sensors 504, 506, . . . , 508, the sensors 504, 506, . . . , 508 may be ranked, for example, in descending order from highest prediction accuracy to lowest prediction accuracy. In some example embodiments, training data streams from the sensors that are below a certain threshold of accuracy may be eliminated, for example, from steps 710, 712. In some alternative embodiments, methods such as mean value, a mean slope, and an exponential decay described above may be used to rank the sensors 504, 506, . . . , 508. The ranking of the sensors may be performed by the preprocessor 520.

After ranking of the sensors is performed at step 708, training of data streams from one or more of the sensors may be excluded from further steps of the method 700. Alternatively, training of data streams from all sensors may continue to be processed.

At step 710, the method 700 includes concatenating cut-size training data segments of the multiple training data streams based on an order of the ranking of the multiple sensors performed at step 708 to generate a concatenated training data stream. The concatenating process at step 710 may be performed by the preprocessor 520. To illustrate, for a fixed cut-size of data, k, (e.g., cut-size, k, of 10 data elements), concatenation may be performed with a first k elements of the training data stream from one sensor (e.g., sensor 504) followed by a first k elements of the training data stream from another sensor (e.g., sensor 506) and so on until the first k elements of the last sensor (e.g., sensor 508) are concatenated. The concatenation at step 710 may continue with the (k+1) to 2*k elements of the first sensor (e.g., sensor 504) again, followed by the (k+1) to 2*k elements of the second sensor, and so on. After (k+1) to 2*k elements from all the sensors are concatenated, the concatenation process may continue with ((2*k)+1) to 3*k elements of the first sensor (e.g., sensor 504), and so on.

In some example embodiments, the cut-size data segments of the multiple training data streams that are concatenated at step 710 may be taken from the training data segments extracted at step 704 instead of directly from the training data streams. The concatenation may be performed in the same manner described above whether the cut-size data segments are taken from the extracted training data segments or directly from the multiple training data streams.

In some example embodiments, the cut-size, k, may be determined empirically. For example, an optimum cut-size may be dependent of the source of the data (e.g., type of sensor, etc.). The cut-size may also be selected by other means as may be contemplated by those of ordinary skill in the art with the benefit of this disclosure.

In some example embodiments, training data streams from a subset of the sensors instead of all the sensors may be used at step 710. For example, the training data streams only from some of the higher ranked sensor may be used at step 710.

In some alternative embodiments, the ranking of the sensors at step 708 may be omitted. To illustrate, the concatenation performed at step 710 may be implemented based on an order of the sensors other than the ranking performed at step 708. The particular order of the sensors, whether determined based on the ranking of the sensors at step 708 or by other means, is used in the prediction of failure as described below.

At step 712, the method 700 includes generating, by the processor, a shapelet-based decision tree. Generating of the shapelet-based decision tree at step 712 includes extracting time series shapelet from the concatenated training data stream generated at step 710. In some embodiments, generating of the shapelet-based decision tree at step 712 may be performed in the same manner as described above with respect to step 408 of FIG. 4.

The method 700 includes receiving test data streams from sensors of second oilfield equipment at step 714. For example, the preprocessor 520 may receive test data streams from the sensors 514, 516, . . . 518 of the second oilfield equipment 512. Each sensor 514, 516, . . . , 518 of the second oilfield equipment 512 measures/senses same parameter as a respective sensor of the multiple sensors 504, 506, . . . , 508 of the first oilfield equipment 502. To illustrate, the sensors 504 and 514 may be temperature sensors, and the sensors 506 and 516 may be pressure sensors, etc.

At step 716, the method 700 includes concatenating cut-size test data segments of the test data streams in order of the ranking of the sensors to generate a concatenated test data stream. The concatenation of the cut-size test data segments is performed at step 716 in a similar manner as described with respect to step 710. To illustrate, the order of the ranking of the sensors determined at step 708 with respect to the sensors 504, 506, . . . , 508 is followed at step 716 in concatenating the cut-size test data segments of the test data streams from the respective sensors 514, 516, . . . , 518. The cut-size, k, is the same both at step 710 and step 716. At step 716, the cut-size test data segments may be taken directly from the test data streams or from test data segments extracted from the test data streams. The test data segments from which the cut-size test data segments are taken may be extracted in the same manner as described with respect to test data segments at step 412. In general, the concatenation of the cut-size test data segments performed at step 716 is performed in the same order, with respect to the sensors 514, 516, . . . , 518, as the respective sensors 504, 506, . . . , 508. If training data stream(s) from a respective one or more sensors of the sensors 504, 506, . . . , 508 were excluded as a result of the ranking at step 708, test data stream(s) from the corresponding one or more sensors of the sensors 514, 516, . . . , 518 are excluded from step 716.

At step 718, the method 700 includes determining, based on the shapelet-based decision tree, whether the concatenated test data stream predicts a failure of the second oilfield equipment. For example, step 718 may be performed in a similar manner as step 412 of FIG. 4. To illustrate, the processor 522 may determine whether the concatenated test data stream predicts a failure of the second oilfield equipment 512 by determining Euclidean distances (or other distances) between each test data segment of the concatenated test data stream and the time series shapelet generated by the processor 522 at step 712. For example, each test data segment may be extracted from the concatenated test data stream in a similar manner as the training data segments are extracted at step 704.

A general description of using interleaved data streams (i.e., concatenated data streams) for failure prediction is provided in “Multivariate Time Series Classification Using Inter-leaved Shapelets,” Om Prasad Patri et al., Multivariate Time Series Classification Using Inter-leaved Shapelets, In the Time Series Workshop at Neural Information Processing Systems (NIPS), NIPS 2015, the entire content of which is incorporated herein by reference.

As discussed hereinabove, one or more of the preprocessors 216, 520 and the processors 218, 522 may be implemented using hardware (e.g., a microprocessor, FPGA, . . . ), software, or a combination of hardware and software. For example, in some embodiments, the preprocessors 216, 520 and the processors 218, 522 may be software, and the systems 200, 500 may each include a physical processor communicatively connected to a memory via a data bus. The physical processor may execute instructions associated with the software represented by the preprocessors 216, 520 and the processors 218, 522. Although the method 700 is described with respect gas compressors, in other example embodiments, the method 700 may be applicable to systems with other oilfield equipment (e.g., ESP) or non-oilfield equipment without departing from the scope of this disclosure.

The physical processor can be any of a variety of types of special-purpose or general-purpose programmable circuits capable of executing computer-readable instructions to perform various tasks, such as mathematical and communication tasks. The memory can include any of a variety of memory devices, such as using various types of computer-readable or computer storage media. A computer storage medium or computer-readable medium may be any medium that can contain or store the program for use by or in connection with the instruction execution system, apparatus, or device. The computer storage media may include dynamic random access memory (DRAM) or variants thereof, solid state memory, read-only memory (ROM), electrically-erasable programmable ROM, optical discs (e.g., CD-ROMs, DVDs, etc.), magnetic disks (e.g., hard disks, floppy disks, etc.), magnetic tapes, and other types of devices and/or articles of manufacture that store data. Computer storage media generally includes at least one or more tangible media or devices. Computer storage media can, in some embodiments, include embodiments including entirely non-transitory components. In the embodiment shown, the memory may store software, a computer-executable application, instructions, data, etc. (referred to as “instructions” for simplicity) that can implement the various methods 400, 600 (or operations) discussed herein.

The storage 210, 510 may be practically anything that can store data, and may be hardware only, software only, or a combination of hardware and software. For example, the storage 210, 510 may be at least one database in some embodiments.

Although the drawings are generally described with respect to oil field equipment, this disclosure may be applied in the context of electricity, for example, as discussed in “Extracting Discriminative Features for Event-based Electricity Disaggregation,” Om Prasad Patri et al., 2014 IEEE Conference on Technologies for Sustainability, Portland, Oreg., USA, 2014, the entire content of which is incorporated herein by reference.

Furthermore, this disclosure may be utilized in the context of tilt meter data. Tilt meter data may measure surface expression or ground expression. For example, ground movement may potentially damage boreholes and/or wells. As tilt meter data may be collected over time, it may be possible to process the data as discussed in this disclosure to detect and possibly even predict future items. This disclosure may also be utilized in the context of pump cards. A pump card is a reading from a dynamometer recorded during one complete cycle of a pump stroke. There are surface pump cards as well as downhole pump cards. Like tilt meter data, these cards can be collected and processed as time series using this disclosure to more quickly identify items and possibly even predict future items. Although the systems, devices and methods are described above in more detail with respect to oilfield equipment, the systems, devices and methods are equally applicable to non-oilfield equipment and applications.

Furthermore, each method claim below (e.g., each computer-implemented method claim) may be rewritten as an apparatus/system claim and/or as a computer readable medium/program product claim. For example, embodiments of a computer implemented method, a computing apparatus (e.g., may include at least one processor (e.g., physical processor) and at least one memory that includes instructions), and a computer program product are provided herein for failure prediction. For example, the computer implemented method may be executed by a computing apparatus. For example, a memory of the computing apparatus may include instructions (even data) that when executed by a processor of the computing apparatus, cause the computing apparatus to predict failure of equipment.

Although some embodiments have been described herein in detail, the descriptions are by way of example. The features of the embodiments described herein are representative and, in alternative embodiments, certain features, elements, and/or steps may be added or omitted. Additionally, modifications to aspects of the embodiments described herein may be made by those skilled in the art without departing from the spirit and scope of the following claims, the scope of which are to be accorded the broadest interpretation so as to encompass modifications and equivalent structures.

What is claimed is:

1. A method for predicting a failure of oilfield equipment based on univariate time series, the method comprising:
providing, by a sensor of first oilfield equipment, training data, wherein a training data stream comprising the training data is received by a preprocessor;
extracting, by the preprocessor, training data segments from one or more portions of the training data stream generated prior to the first oilfield equipment failing to operate normally, wherein portions of the training data in the one or more portions of the training data stream were sampled at a regular sampling rate;
identifying each training data segment of the training data segments as corresponding to a normal operational state of the first oilfield equipment or a failed state of the first oilfield equipment, wherein the failed state of the first oilfield equipment corresponds to the oilfield equipment failing to operate normally;
generating, by a processor, a shapelet-based decision tree, wherein generating the shapelet-based decision tree includes extracting one or more time series shapelets from one or more training data segments of the training data segments;
receiving a test data stream from a sensor of second oilfield equipment;
determining by the processor, based on the shapelet-based decision tree, whether one or more test data segments extracted from the test data stream predict a failure of the second oilfield equipment.

2. The method of claim 1, wherein the one or more test data segments are extracted from one or more portions of the test data stream and wherein test data in the one or more portions of the test data stream were sampled at the regular sampling rate.

3. The method of claim 1, wherein determining whether the one or more test data segments predict the failure of the second oilfield equipment based on the shapelet-based decision tree includes determining Euclidean distances between each test data segment of the one or more test data segments and the one or more time series shapelets.

4. The method of claim 1, further comprising predicting the failure of the second oilfield equipment if a ratio of a number of test data segments that predict the failure of the second oilfield equipment processed based on the shapelet-based decision tree to a total number of the one or more test data segments exceeds a threshold.

5. The method of claim 1, wherein extracting the training data segments from the one or more portions of the training data stream includes excluding a portion of the training data stream that includes invalid data.

6. The method of claim 1, wherein the training data segments are extracted from the one or more portions of the training data stream such that two consecutive data segments have overlapping data portions and non-overlapping data portions, wherein the overlapping data portions are less than a threshold percentage of the length of the training data segments.

7. The method of claim 1, wherein extracting the one or more time series shapelets from the one or more training data segments of the training data segments is performed using a Fast-Shapelet method.

8. The method of claim 1, wherein identifying each training data segment of the training data segments as corresponding to the normal operational state of the first oilfield equipment or the failure state of the first oilfield equipment is performed based on information identifying a portion of the training data stream that is generated by the sensor of first oilfield equipment while the first oilfield equipment was in the failed state.

9. The method of claim 1, wherein the first oilfield equipment and the second oilfield equipment are electric submersible pumps or wherein the first oilfield equipment and the second oilfield equipment are gas compressors.

10. A system for predicting a failure of oilfield equipment based on univariate time series, the system comprising:
a data storage device to store and provide a training data stream generated by a sensor of first oilfield equipment;
a preprocessor to extract training data segments from one or more portions of a training data stream that include training data generated prior to the first oilfield equipment failing to operate normally, wherein the training data in the one or more portions of the training data streams were sampled at a regular sampling rate, wherein the preprocessor identifies each training data segment of the training data segments as corresponding to a normal operational state of the first oilfield equipment or a failure state of the first oilfield equipment, wherein the failure state of the first oilfield equipment corresponds to the oilfield equipment failing to operate normally; and
a processor to generate a shapelet-based decision tree by extracting one or more time series shapelets from one or more training data segments of the training data segments, wherein the preprocessor receives a test data stream generated by a sensor of second oilfield equipment, and wherein the processor determines, based on the shapelet-based decision tree, whether one or more test data segments extracted from the test data stream predict a failure of the second oilfield equipment.

11. The system of claim 10, wherein the preprocessor extracts the one or more test data segments from one or more portions of the test data stream and wherein test data in the one or more portions of the test data stream were sampled at the regular sampling rate.

12. The system of claim 10, wherein the processor determines whether the one or more test data segments predict the failure of the second oilfield equipment based on the shapelet-based decision tree by determining Euclidean distances between each test data segment of the one or more test data segments and the one or more time series shapelets.

13. The system of claim 10, wherein the processor indicates a prediction of the failure of the second oilfield equipment if a ratio of a number of test data segments that predict the failure of the second oilfield equipment processed based on the shapelet-based decision tree to a total number of the one or more test data segments exceeds a threshold.

14. The system of claim 10, wherein the preprocessor extracts the training data segments from the one or more portions of the training data stream by excluding a portion of the training data stream that includes invalid data.

15. The system of claim 10, wherein the first oilfield equipment and the second oilfield equipment are electric submersible pumps and wherein the training data stream and the testing data stream include voltage data, current data, or intake pressure data.

16. A method of predicting a failure of oilfield equipment based on multivariate time series, the method comprising:
receiving multiple training data streams generated by multiple sensors of first oilfield equipment, wherein the multiple training data streams are time-wise synchronized with each other;
extracting, by a preprocessor, training data segments from a portion of each training data stream of the multiple training data streams, the portion of each training data stream including training sensor data generated prior to the first oilfield equipment failing to operate normally;
identifying each training data segment of the multiple training data segments as corresponding to a normal operational state of the first oilfield equipment or a failed state of the first oilfield equipment, wherein the failed state of the first oilfield equipment corresponds to the first oilfield equipment failing to operate normally;
selecting a subset of training data streams from the multiple training data streams based on computed feature values of each training data segment of the multiple training data segments and based on identification of each training data segment as corresponding to the normal operational state of the first oilfield equipment or the failed state of the first oilfield equipment, wherein each training data stream of the subset of training data streams is generated by a respective sensor of a subset of the multiple sensors;
generating, by a processor, shapelet-based decision trees, wherein generating the shapelet-based decision trees includes extracting time series shapelets from training data segments extracted from the subset of the training data segments;
receiving test data streams from a subset of sensors of second oilfield equipment, wherein each sensor of the subset of the sensors of the second oilfield equipment measures same parameter as a respective sensor of the subset of the multiple sensors of the first oilfield equipment; and
determining by the processor, based on the shapelet-based decision trees, whether test data segments extracted from the test data streams predict a failure of the second oilfield equipment.

17. The method of claim 16, wherein the computed feature values of each training data segment of the multiple training data segments include two or more of a mean value, a missing data points value, a mean slope, a ratio of measurements, and an exponential decay value.

18. The method of claim 17, selecting the subset of the training data streams from the multiple training data streams includes performing linear classifications of the computed features of each training data segment of the training data segments.

19. The method of claim 16, further comprising indicating a predication of the failure of the second oilfield equipment if a majority of predictions based on the shapelet-based decision trees predict the failure of the second oilfield equipment.

20. The method of claim 16, wherein the first oilfield equipment and the second oilfield equipment are electric submersible pumps or wherein the first oilfield equipment and the second oilfield equipment are gas compressors.

21. A method of predicting a failure of oilfield equipment based on multivariate time series, the method comprising:
concatenating, by a preprocessor, cut-size training data segments of multiple training data streams to generate a concatenated training data stream based on an order of a ranking of multiple sensors of first oilfield equipment, wherein the multiple training data streams are received from the multiple sensors of first oilfield equipment and wherein the multiple training data streams are time-wise synchronized with each other;
generating, by a processor, a shapelet-based decision tree, wherein generating the shapelet-based decision tree includes extracting one or more time series shapelets from the concatenated training data stream;
concatenating cut-size test data segments of test data streams in the order of the ranking of the multiple sensors of the first oilfield equipment to generate a concatenated test data stream, wherein the test data streams are received from sensor of second oilfield equipment; and
determining by the processor, based on the shapelet-based decision tree, whether the concatenated test data stream predicts a failure of the second oilfield equipment.

22. The method of claim 21, further comprising:
providing multiple training data by the multiple sensors of first oilfield equipment, wherein the multiple training data streams comprise the multiple training data and wherein the multiple training data streams are received by the preprocessor;
extracting, by the preprocessor, the training data segments from a portion of each training data stream of the multiple training data streams; and
identifying each training data segment of the multiple training data segments as corresponding to a normal operational state of the first oilfield equipment or a failed state of the first oilfield equipment.

23. The method of claim 22, wherein the portion of each training data stream includes training sensor data generated prior to the first oilfield equipment failing to operate normally and wherein the failed state of the first oilfield equipment corresponds to the first oilfield equipment failing to operate normally

24. The method of claim 21, further comprising ranking the multiple sensors of the first oilfield equipment based on the multiple training data streams.

25. The method of claim 21, wherein each sensor of the second oilfield equipment measures same parameter as a respective sensor of the multiple sensors of the first oilfield equipment.
